(19) United States
(12) Patent Application Publication
(10) Pub. No.: US 2015/0213047 A1
(43) Pub. Date: Jul. 30, 2015

(54) COALESCING SEQUENCES FOR HOST SIDE DEDUPLICATION

(71) Applicant: NetApp Inc., Sunnyvale, CA (US)

(72) Inventor: Anshul Madan, Brookline, MA (US)

(73) Assignee: NetApp Inc., Sunnyvale, CA (US)

(21) Appl. No.: 14/162,868

(22) Filed: Jan. 24, 2014

(51) Int. Cl. G06F 17/30

(52) U.S. Cl. CPC G06F 17/30156; G06F 17/30091

(57) ABSTRACT

One or more techniques and/or systems are provided for coalescing sequences for host side deduplication. A host device may receive a write command from a client device. The write command may comprise a set of data blocks that are to be written to a storage device. The host device may perform host side deduplication by identifying one or more data blocks of the write command that comprise data already stored by the storage device as storage device data blocks. The host device may evaluate the one or more data blocks to identify adjacent data blocks. The host device may coalesce adjacent data blocks into a deduplication sequence. The host device may issue a host side write deduplication command to the storage device (e.g., through a storage controller) based upon the deduplication sequence, which may improve performance by mitigating a number of commands issued to and/or processed by the storage device.

### BACKGROUND

A network storage environment may comprise one or more network storage controllers configured to provide host computing devices with access to data stored on storage devices accessible from the respective network storage controllers. In particular, a host computing device may connect to a network storage controller that may provide the host computing device with I/O access to a storage device accessible to and/or managed by the network storage controller. In an example, a client device may connect to the host computing device. The client device may send an I/O command to the host computing device (e.g., an administrator on the client device may submit a write command to a storage application executing on the host computing device). The host computing device, such as the storage application, may determine that the network storage controller manages a storage device to which the write command is to write data. Accordingly, the host computing device may send the write command to the network storage controller. The network storage controller may store a significant amount of duplicate (e.g., redundant) data within the storage device (e.g., the storage device may store data for 50 virtual machine backup files that have overlapping operating system data). Accordingly, network storage controllers may perform server side deduplication to mitigate storage of duplicate data. That is, a network storage controller may comprise deduplication functionality to detect whether data blocks of a write command from a host computing device are already stored by the network storage controller on a storage device. If a data block is not already stored by the network storage controller, then the network storage controller may write the data block within a destination location on the storage device. If the data block is already stored within the storage device, then the network storage controller may merely store a reference within the destination location that points to a source location within the storage device that already comprises the data block or the network storage controller may copy the data block from the source location to the destination location.

### DESCRIPTION OF THE DRAWINGS

FIG. 1 is a component block diagram illustrating an example clustered network in accordance with one or more of the provisions set forth herein.

FIG. 2 is a component block diagram illustrating an example data storage system in accordance with one or more of the provisions set forth herein.

FIG. 3 is a flow chart illustrating an exemplary method of coalescing sequences for host side deduplication.

FIG. 4 is a component block diagram illustrating an exemplary system for coalescing sequences for host side deduplication.

FIG. 5A is an example of a coalescence component evaluating a first adjacent block address structure corresponding to a signature of a tenth data block.

FIG. 5B is an example of a coalescence component evaluating a second adjacent block address structure corresponding to a signature of the eleventh data block.

FIG. 5C is an example of the coalescence component evaluating a third adjacent block address structure corresponding to a signature of the twelfth data block.

FIG. 6 is a component block diagram illustrating an exemplary system for coalescing sequences for deduplication.

FIG. 7 is an example of a computer readable medium in accordance with one or more of the provisions set forth herein.

### DETAILED DESCRIPTION

Some examples of the claimed subject matter are now described with reference to the drawings, where like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. Nothing in this detailed description is admitted as prior art.

One or more systems and/or techniques for coalescing sequences for host side (e.g., rather than server side) deduplication are provided. For example, a client device may issue a write command to a host device that is configured to provide the client device with access to data stored within a storage device through a storage controller that interfaces with the storage device. The host device may perform host side deduplication upon data blocks within the write command to identify one or more data blocks already stored by the storage device. It may be appreciated that a data block may comprise any amount of data and is not limited to a specific block size. As provided herein, adjacent data blocks of the one or more data blocks already stored by the storage device may be coalesced into a deduplication sequence. For example, the storage device may store a first storage device data block (e.g., corresponding to a first data block of the write command), a second storage device data block (e.g., corresponding to a second data block of the write command) adjacent to the first storage device data block, a third storage device data block (e.g., corresponding to a third data block of the write command) adjacent to the second storage device data block, and/or other adjacent/sequential storage device data blocks corresponding to data blocks of the write command. Accordingly, the first data block, the second data block, the third data block, and/or other data blocks of the write command that correspond to adjacent storage device data blocks are coalesced into a deduplication sequence (e.g., the data blocks are grouped together so that a single deduplication command may be issued for multiple adjacent data blocks).

A host side write deduplication command may be issued to the storage device based upon the deduplication sequence. In an example, the host side write deduplication command is issued to a network storage controller configured to implement I/O commands on the storage device and/or other storage devices managed by the network storage controller. The host side write deduplication command may specify to the storage device that a first destination location of the first data block is to reference a first block address of the first storage device data block already stored by the storage device, that a second destination location of the second data block is to reference a second block address of the second storage device data block already stored by the storage device, that a third destination location of the third data block is to reference a third block address of the third storage device data block already stored by the storage device, etc. In this way, the host side write deduplication command is sent as a single communication command between the host device and the storage device (e.g., such as through the network storage controller to the storage device), which may mitigate the number of commands sent by the host to the storage device to improve performance of the storage device (e.g., response time for write commands may improve). Performing deduplication at the host device mitigates unnecessary utilization of network resources (e.g., issuing a write command that transfers redundant data to the storage device over a network).

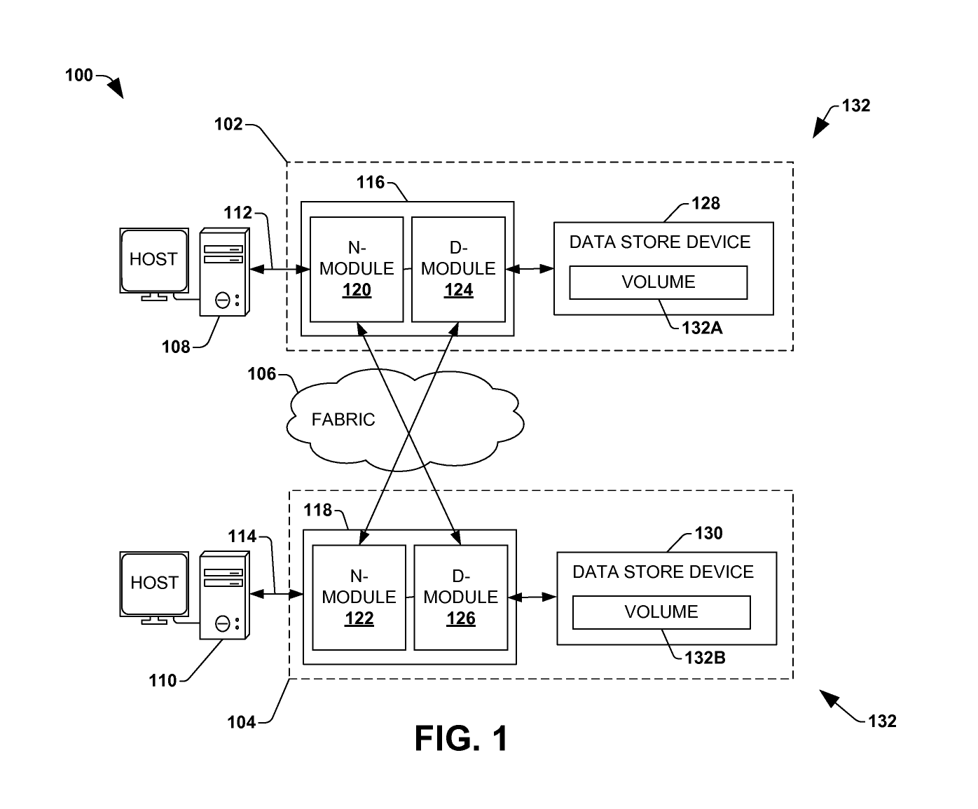

To provide context for coalescing sequences for host side deduplication, FIG. 1 illustrates an embodiment of a clustered network environment 100. It may be appreciated, however, that the techniques, etc. described herein may be implemented within the clustered network environment 100, a non-cluster network environment, and/or a variety of other computing environments, such as a desktop computing environment. That is, the instant disclosure, including the scope of the appended claims, is not meant to be limited to the examples provided herein. It will be appreciated that where the same or similar components, elements, features, items, modules, etc. are illustrated in later figures but were previously discussed with regard to prior figures, that a similar (e.g., redundant) discussion of the same may be omitted when describing the subsequent figures (e.g., for purposes of simplicity and ease of understanding).

FIG. 1 is a block diagram illustrating an example clustered network environment 100 that may implement at least some embodiments of the techniques and/or systems described herein. The example environment 100 comprises data storage systems 102 and 104 that are coupled over a cluster fabric 106, such as a computing network embodied as a private Infiniband or Fibre Channel (FC) network facilitating communication between the storage systems 102 and 104 (and one or more modules, component, etc. therein, such as, nodes 116 and 118, for example). It will be appreciated that while two data storage systems 102 and 104 and two nodes 116 and 118 are illustrated in FIG. 1, that any suitable number of such components is contemplated. Similarly, unless specifically provided otherwise herein, the same is true for other modules, elements, features, items, etc. referenced herein and/or illustrated in the accompanying drawings. That is, a particular number of components, modules, elements, features, items, etc. disclosed herein is not meant to be interpreted in a limiting manner.

It will be further appreciated that clustered networks are not limited to any particular geographic areas and can be clustered locally and/or remotely. Thus, in one embodiment a clustered network can be distributed over a plurality of storage systems and/or nodes located in a plurality of geographic locations; while in another embodiment a clustered network can include data storage systems (e.g., 102, 104) residing in a same geographic location (e.g., in a single onsite rack of data storage devices).

In the illustrated example, one or more host devices 108, 110 which may comprise, for example, personal computers (PCs), computing devices used for storage (e.g., storage servers), and other computers or peripheral devices (e.g., printers), are coupled to the respective data storage systems 102, 104 by storage network connections 112, 114. Network connection may comprise a local area network (LAN) or wide area network (WAN), for example, that utilizes Network Attached Storage (NAS) protocols, such as a Common Internet File System (CIFS) protocol or a Network File System (NFS) protocol to exchange data packets. Illustratively, the host devices 108, 110 may be general-purpose computers running applications, and may interact with the data storage systems 102, 104 using a client/server model for exchange of information. That is, the host device may request data from the data storage system (e.g., data on a storage device managed by a network storage control configured to process I/O commands issued by the host device for the storage device), and the data storage system may return results of the request to the host device via one or more network connections 112, 114.

The nodes 116, 118 on clustered data storage systems 102, 104 can comprise network or host nodes that are interconnected as a cluster to provide data storage and management services, such as to an enterprise having remote locations, for example. Such a node in a data storage and management network cluster environment 100 can be a device attached to the network as a connection point, redistribution point or communication endpoint, for example. A node may be capable of sending, receiving, and/or forwarding information over a network communications channel, and could comprise any device that meets any or all of these criteria. One example of a node may be a data storage and management server attached to a network, where the server can comprise a general purpose computer or a computing device particularly configured to operate as a server in a data storage and management system.

As illustrated in the exemplary environment 100, nodes 116, 118 can comprise various functional components that coordinate to provide distributed storage architecture for the cluster. For example, the nodes can comprise a network module 120, 122 (e.g., N-Module, or N-Blade) and a data module 124, 126 (e.g., D-Module, or D-Blade). Network modules 120, 122 can be configured to allow the nodes 116, 118 (e.g., network storage controllers) to connect with host devices 108, 110 over the network connections 112, 114, for example, allowing the host devices 108, 110 to access data stored in the distributed storage system. Further, the network modules 120, 122 can provide connections with one or more other components through the cluster fabric 106. For example, in FIG. 1, a first network module 120 of first node 116 can access a second data storage device 130 by sending a request through a second data module 126 of a second node 118.

Data modules 124, 126 can be configured to connect one or more data storage devices 128, 130, such as disks or arrays of disks, flash memory, or some other form of data storage, to the nodes 116, 118. The nodes 116, 118 can be interconnected by the cluster fabric 106, for example, allowing respective nodes in the cluster to access data on data storage devices 128, 130 connected to different nodes in the cluster. Often, data modules 124, 126 communicate with the data storage devices 128, 130 according to a storage area network (SAN) protocol, such as Small Computer System Interface (SCSI) or Fiber Channel Protocol (FCP), for example. Thus, as seen from an operating system on a node 116, 118, the data storage devices 128, 130 can appear as locally attached to the operating system. In this manner, different nodes 116, 118, etc. may access data blocks through the operating system, rather than expressly requesting abstract files.

It should be appreciated that, while the example embodiment 100 illustrates an equal number of N and D modules, other embodiments may comprise a differing number of these modules. For example, there may be a plurality of N and/or D modules interconnected in a cluster that does not have a one-to-one correspondence between the N and D modules. That is, different nodes can have a different number of N and D modules, and the same node can have a different number of N modules than D modules.

Further, a host device 108, 110 can be networked with the nodes 116, 118 in the cluster, over the networking connections 112, 114. As an example, respective host devices 108, 110 that are networked to a cluster may request services (e.g., exchanging of information in the form of data packets) of a node 116, 118 in the cluster, and the node 116, 118 can return results of the requested services to the host devices 108, 110. In one embodiment, the host devices 108, 110 can exchange information with the network modules 120, 122 residing in the nodes (e.g., network hosts) 116, 118 in the data storage systems 102, 104.

In one embodiment, the data storage devices 128, 130 comprise volumes 132, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume.

Volumes are typically configured in formats that may be associated with particular storage systems, and respective volume formats typically comprise features that provide functionality to the volumes, such as providing an ability for volumes to form clusters. For example, where a first storage system may utilize a first format for their volumes, a second storage system may utilize a second format for their volumes.

In the example environment 100, the host devices 108, 110 can utilize the data storage systems 102, 104 to store and retrieve data from the volumes 132. In this embodiment, for example, the host device 108 can send data packets to the N-module 120 in the node 116 within data storage system 102. The node 116 can forward the data to the data storage device 128 using the D-module 124, where the data storage device 128 comprises volume 132A. In this way, in this example, the host device can access the storage volume 132A, to store and/or retrieve data, using the data storage system 102 connected by the network connection 112. Further, in this embodiment, the host device 110 can exchange data with the N-module 122 in the host 118 within the data storage system 104 (e.g., which may be remote from the data storage system 102). The host 118 can forward the data to the data storage device 130 using the D-module 126, thereby accessing volume 132B associated with the data storage device 130.

It may be appreciated that host side deduplication may be implemented within the clustered network environment 100. For example, a host device (e.g., host devices 108, 110) may comprise a coalescence component configured to perform host side deduplication before sending storage data commands to a network storage controller (e.g., nodes 116, 118) configured to implement such storage data commands on a storage device such as data storage 128, 130. Host side deduplication may mitigate unnecessary network traffic over the storage network connections 112, 114 (e.g., data already stored by nodes 116, 118 within data storage 128, 130 may not be retransmitted over network connections 112, 114).

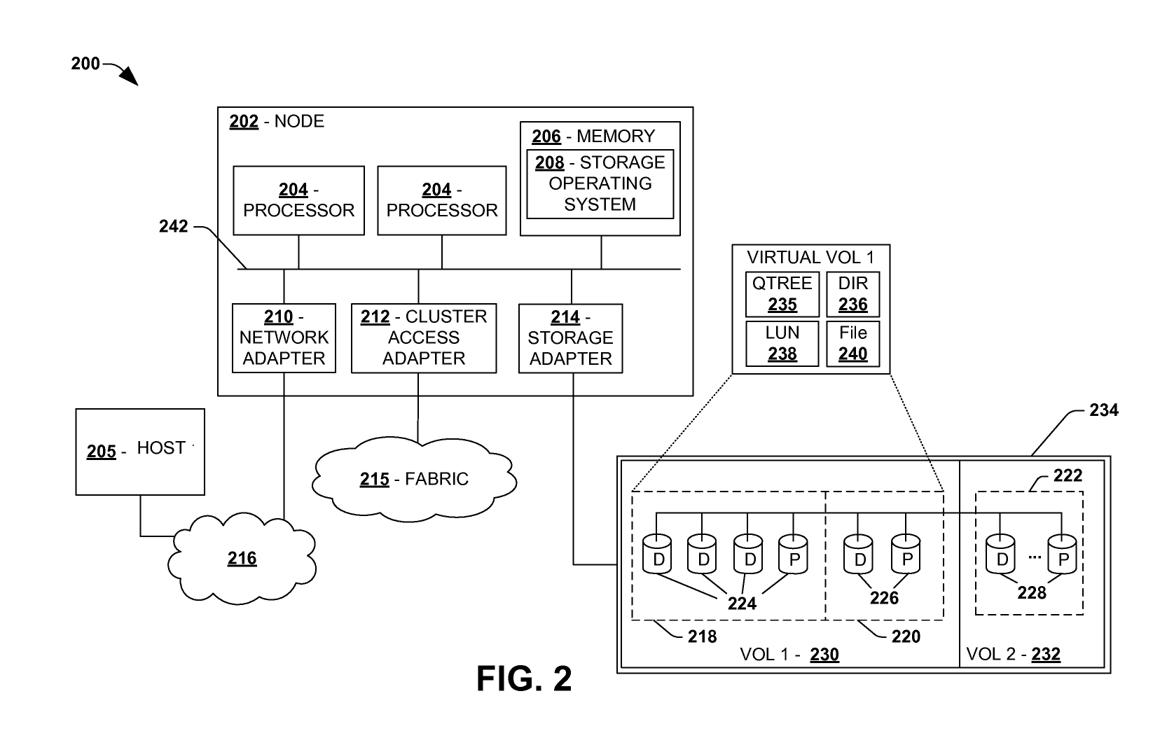

FIG. 2 is an illustrative example of a data storage system 200 (e.g., 102, 104 in FIG. 1), providing further detail of an embodiment of components that may implement one or more of the techniques and/or systems described herein. The example data storage system 200 comprises a node 202 (e.g., host nodes 116, 118 in FIG. 1), and a data storage device 234 (e.g., data storage devices 128, 130 in FIG. 1). The node 202 may be a general purpose computer, for example, or some other computing device particularly configured to operate as a storage server. A host device 205 (e.g., 108, 110 in FIG. 1) can be connected to the node 202 over a network 216, for example, to provides access to files and/or other data stored on the data storage device 234.

The data storage device 234 can comprise mass storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information.

The node 202 comprises one or more processors 204, a memory 206, a network adapter 210, a cluster access adapter 212, and a storage adapter 214 interconnected by a system bus 242. The storage system 200 also includes an operating system 208 installed in the memory 206 of the node 202 that can, for example, implement a Redundant Array of Independent (or Inexpensive) Disks (RAID) optimization technique to optimize a reconstruction process of data of a failed disk in an array.

The operating system 208 can also manage communications for the data storage system, and communications between other data storage systems that may be in a clustered network, such as attached to a cluster fabric 215 (e.g., 106 in FIG. 1). Thus, the node 202, such as a network storage controller, can respond to host device requests to manage data on the data storage device 234 (e.g., or additional clustered devices) in accordance with these host device requests. The operating system 208 can often establish one or more file systems on the data storage system 200, where a file system can include software code and data structures that implement a persistent hierarchical namespace of files and directories, for example. As an example, when a new data storage device (not shown) is added to a clustered network system, the operating system 208 is informed where, in an existing directory tree, new files associated with the new data storage device are to be stored. This is often referred to as “mounting” a file system.

In the example data storage system 200, memory 206 can include storage locations that are addressable by the processors 204 and adapters 210, 212, 214 for storing related software program code and data structures. The processors 204 and adapters 210, 212, 214 may, for example, include processing elements and/or logic circuitry configured to execute the software code and manipulate the data structures. The operating system 208, portions of which are typically resident in the memory 206 and executed by the processing elements, functionally organizes the storage system by, among other things, invoking storage operations in support of a file service implemented by the storage system. It will be apparent to those skilled in the art that other processing and memory mechanisms, including various computer readable media, may be used for storing and/or executing program instructions pertaining to the techniques described herein. For example, the operating system can also utilize one or more control files (not shown) to aid in the provisioning of virtual machines.

The network adapter 210 includes the mechanical, electrical and signaling circuitry needed to connect the data storage system 200 to a host device 205 over a computer network 216, which may comprise, among other things, a point-to-point connection or a shared medium, such as a local area network. The host device 205 (e.g., 108, 110 of FIG. 1) may be a general-purpose computer configured to execute applications. As described above, the host device 205 may interact with the data storage system 200 in accordance with a client/host model of information delivery.

The storage adapter 214 cooperates with the operating system 208 executing on the node 202 to access information requested by the host device 205 (e.g., access data on a storage device managed by a network storage controller). The information may be stored on any type of attached array of writeable media such as magnetic disk drives, flash memory, and/or any other similar media adapted to store information. In the example data storage system 200, the information can be stored in data blocks on the disks 224, 226, 228. The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fiber Channel Protocol (FCP)). The information is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the host device 205 over the network connection 216 (and/or returned to another node attached to the cluster over the cluster fabric 215).

In one embodiment, storage of information on arrays 218, 220, 222 can be implemented as one or more storage “volumes” 230, 232 that are comprised of a cluster of disks 224, 226, 228 defining an overall logical arrangement of disk space. The disks 224, 226, 228 that comprise one or more volumes are typically organized as one or more groups of RAIDs. As an example, volume 230 comprises an aggregate of disk arrays 218 and 220, which comprise the cluster of disks 224 and 226.

In one embodiment, to facilitate access to disks 224, 226, 228, the operating system 208 may implement a file system (e.g., write anywhere file system) that logically organizes the information as a hierarchical structure of directories and files on the disks. In this embodiment, respective files may be implemented as a set of disk blocks configured to store information, whereas directories may be implemented as specially formatted files in which information about other files and directories are stored.

Whatever the underlying physical configuration within this data storage system 200, data can be stored as files within physical and/or virtual volumes, which can be associated with respective volume identifiers, such as file system identifiers (FSIDs), which can be 32-bits in length in one example.

A physical volume, which may also be referred to as a “traditional volume” in some contexts, corresponds to at least a portion of physical storage devices whose address, addressable space, location, etc. doesn't change, such as at least some of one or more data storage devices 234 (e.g., a Redundant Array of Independent (or Inexpensive) Disks (RAID system)). Typically the location of the physical volume doesn't change in that the (range of) address(es) used to access it generally remains constant.

A virtual volume, in contrast, is stored over an aggregate of disparate portions of different physical storage devices. The virtual volume may be a collection of different available portions of different physical storage device locations, such as some available space from each of the disks 224, 226, and/or 228. It will be appreciated that since a virtual volume is not “tied” to any one particular storage device, a virtual volume can be said to include a layer of abstraction or virtualization, which allows it to be resized and/or flexible in some regards.

Further, a virtual volume can include one or more logical unit numbers (LUNs) 238, directories 236, qtrees 235, and files 240. Among other things, these features, but more particularly LUNS, allow the disparate memory locations within which data is stored to be identified, for example, and grouped as data storage unit. As such, the LUNs 238 may be characterized as constituting a virtual disk or drive upon which data within the virtual volume is stored within the aggregate. For example, LUNs are often referred to as virtual drives, such that they emulate a hard drive from a general purpose computer, while they actually comprise data blocks stored in various parts of a volume.

In one embodiment, one or more data storage devices 234 can have one or more physical ports, wherein each physical port can be assigned a target address (e.g., SCSI target address). To represent respective volumes stored on a data storage device, a target address on the data storage device can be used to identify one or more LUNs 238. Thus, for example, when the node 202 connects to a volume 230, 232 through the storage adapter 214, a connection between the node 202 and the one or more LUNs 238 underlying the volume is created.

In one embodiment, respective target addresses can identify multiple LUNs, such that a target address can represent multiple volumes. The I/O interface, which can be implemented as circuitry and/or software in the storage adapter 214 or as executable code residing in memory 206 and executed by the processors 204, for example, can connect to volume 230 by using one or more addresses that identify the LUNs 238.

It may be appreciated that host side deduplication may be implemented between a host computing device (e.g., host device 205) and a storage server such as a network storage controller (e.g., node 202). For example, host device 205 may comprise a coalescence component configured to perform host side deduplication before sending storage data commands to node 202 that is configured to implement such storage data commands on a storage device, such as data storage device 234. Host side deduplication may mitigate unnecessary network traffic over the network connection 216 (e.g., data already stored by node 202 within data storage device 234 may not be retransmitted over network connection 216).

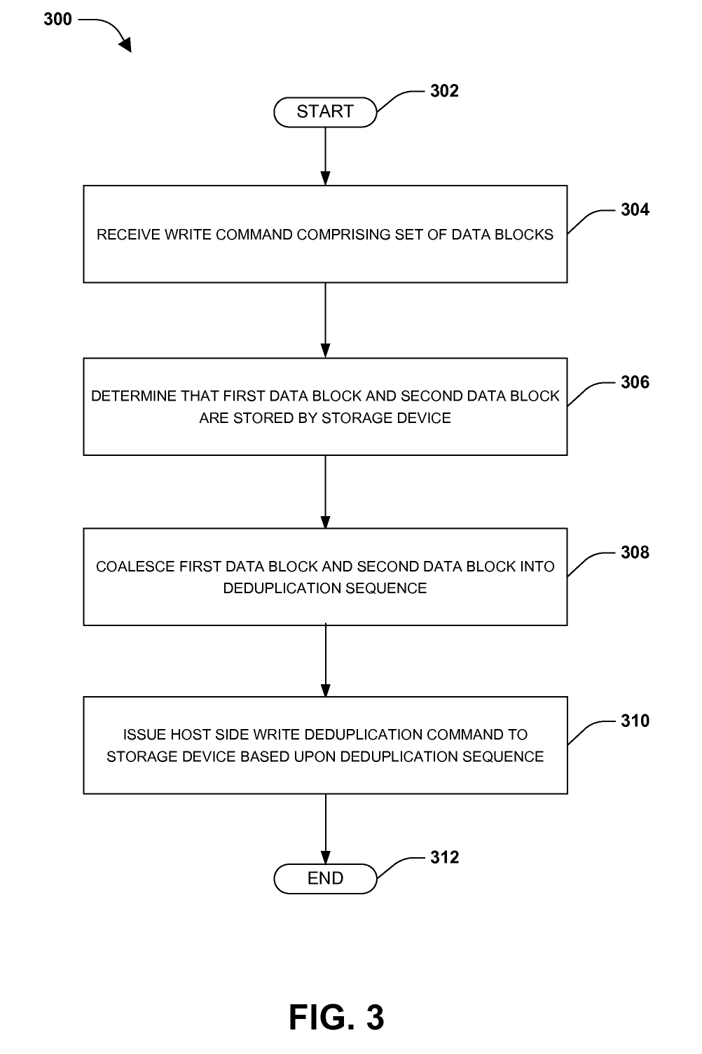

One embodiment of coalescing sequences for host side deduplication is illustrated by an exemplary method 300 of FIG. 3. At 302, the method starts. A host device may be configured provide to a client device with I/O access to a storage device. For example, the host device may comprise a server executing an application (e.g., an application that causes data to be stored on the storage device) accessible to the client device. At 304, the host device may receive a write command from the client device. The write command may comprise a set of data blocks that are to be written to the storage device by the host device (e.g., through a storage controller). It may be appreciated that a data block may comprise any size of data. The host device, such as comprising a coalescence component, may evaluate the set of data blocks to identify one or more data blocks that are already stored by the storage device as storage device data blocks (e.g., a first data block of the write command may comprise the same data as a first storage device data block already stored by the storage device). Such data blocks may be deemed as redundant data blocks with respect to the storage device, and thus it may be advantageous to mitigate transfer of the redundant data blocks from the host to the storage device to same network bandwidth.

At 306, a determination may be made that a first data block, a second data block, and/or other data blocks within the set of data blocks (e.g., a third data block) are stored by the storage device (e.g., as storage device data blocks). In an example, a first signature, such as a first hash value, for the first data block may be determined. A fingerprint data structure may be queried using the first signature to identify a first entry indicating that the storage device comprises a first storage device data block corresponding to (e.g., comprising the same data as) the first data block. In another example, a second signature, such as a second hash value, for the second data block may be determined. The fingerprint data structure may be queried using the second signature to identify a second entry indicating that the storage device comprises a second storage device data block corresponding to (e.g., comprising the same data as) the second data block.

The one or more data blocks, corresponding to storage device data blocks stored by the storage device, may be evaluated to determine adjacent data blocks that may be coalesced together into a single deduplication command for communication to the storage device, which may improve network bandwidth utilization and/or storage device processing (e.g., merely a single deduplication command may be processed as opposed to multiple deduplication commands). In an example, adjacent block address structures, such as left leaning red-black trees, may be maintained for storing addresses corresponding to the signatures of data blocks. The adjacent block address structures (e.g. left leaning red-black tree) may be evaluated to determine whether data blocks are adjacent data blocks (e.g., data blocks corresponding to storage device data blocks that are stored in sequential/contiguous address locations within the storage device). In an example, there is a one-to-one correspondence between signatures (e.g., hash values) and tree structures. That is, a first signature corresponds to a first tree structure, a second signature corresponds to a second tree structure, etc. If a first data block and a second data block of a write command both have the same signature (e.g., called the first signature), then a first address of the first data block and a second address of the second data block are added into the first tree structure. While evaluating a subsequent write command, the first address and the second address within the first tree structure may be evaluated during coalescing.

In an example, a first adjacent block address structure, corresponding to the first signature of the first data block, may be evaluated to identify a first block address of the first storage device data block (e.g., stored by the storage device) corresponding to the first data block. For example, a breadth first search of the first adjacent block address structure may be performed to identify the first block address. The first block address may be incremented to obtain an incremented first block address. A second adjacent block address structure, corresponding to the second signature of the second data block, may be evaluated (e.g., a breadth first search may be performed) to determine whether the incremented first block address corresponds to any of the second block address of the second storage device data block (e.g., stored by the storage device) corresponding to the second data block. Responsive to determining that the incremented first block address corresponds to the second block address, the first data block and the second data block may be determined as adjacent data blocks.

It may be appreciated that multiple adjacent block address structures and/or data blocks (e.g., the third data block) may be evaluated, and that merely two adjacent block address structures and two data blocks are described for simplicity. It may be appreciated that multiple potential sequences of adjacent data blocks may be evaluated and that merely a single sequences is described for simplicity. For example, a sequence may have more than two data blocks. In an example, a third data block is determined to be adjacent (or not) a first sequence, where the first sequence may, for example, comprise a first data block and a second data block. The method 100 may thus loop back to coalesce additional data blocks, such as where a third data block is coalesced (or not) with first and second data blocks after the first and second data blocks have been coalesced. Different numbers of data blocks are contemplated and the instant application, including the scope of the appended claims, is not to be limited to or by the examples provided herein. In an example, a set of potential sequences of adjacent data blocks may be identified. A sequence pruning technique may be performed to select a potential sequence from the set of potential sequences (e.g., a longest sequence of adjacent data blocks; a sequence comprising a number of adjacent data blocks above a coalescence sequence threshold; etc.) to use for coalescing of adjacent data blocks into a deduplication sequence.

At 308, the first data block, the second data block, and/or other adjacent data blocks (e.g., data blocks corresponding to storage device data blocks that are stored in contiguous address locations within the storage device, such as the third data block) are coalesced into a deduplication sequence. At 310, a host side write deduplication command may be issued to the storage device (e.g., such as to a network storage controller configured to implement I/O commands on the storage device) based upon the deduplication sequence. The host side write deduplication command may specify that a first destination location of the first data block (e.g., a first destination on the storage device to which the write command was to write the first data block) is to reference (e.g., create a pointer; copy the first storage device data block to the destination location; etc.) the first block address of the first storage device data block corresponding to the first data block (e.g., a storage location of the first storage device data block within the storage device). The host side write deduplication command may specify that a second destination location of the second data block (e.g., a second destination on the storage device to which the write command was to write the second data block) is to reference (e.g., create a pointer; copy the second storage device data block to the destination location; etc.) the second block address of the second storage device data block corresponding to the second data block (e.g., a storage location of the second storage device data block within the storage device). The host side write deduplication command may be issued as a single communication command between the host device and the storage device, which may improve performance (e.g., response time of write commands) compared to sending individual deduplication commands for respective data blocks.

In an example, a coalescence sequence threshold may be maintained. The coalescence sequence may correspond to a threshold number of adjacent data blocks for coalescing into a single deduplication command. Responsive to the deduplication sequence satisfying the coalescence sequence threshold (e.g., a deduplication sequence of 4 adjacent data blocks may satisfy a coalescence sequence threshold of 3), the host side write deduplication command may be issued. Responsive to the deduplication sequence not satisfying the coalescence sequence threshold (e.g., a deduplication sequence of 2 adjacent data blocks may not satisfy a coalescence sequence threshold of 3), the host side write deduplication command may not be issued (e.g., separate deduplication commands may be sent for respective data blocks; write commands may be sent for respective data blocks; etc.). Communication may be evaluated between the host device and the storage device to identify a storage metric (e.g., a response time for write commands; network bandwidth; utilization of a network storage controller for the storage device; etc.). The coalescence sequence threshold may be dynamically adjusted based upon the storage metric (e.g., the coalescence sequence threshold may be increased or decreased to improve performance, such as response time for write commands). At 312, the method ends.

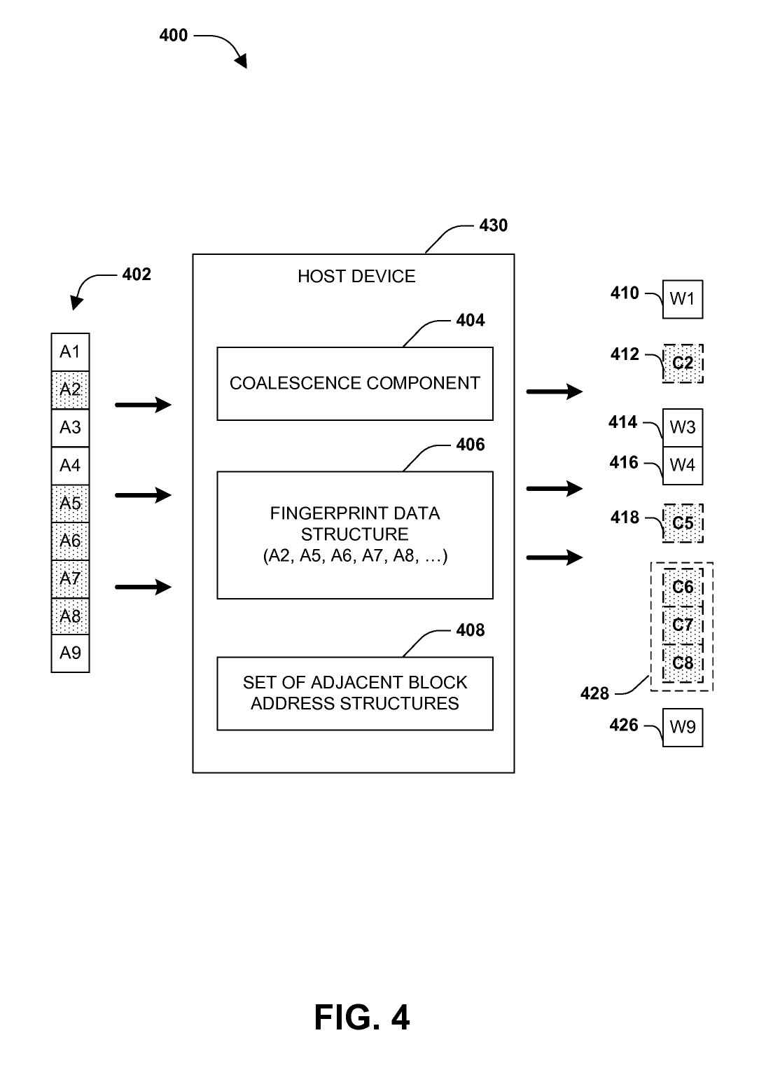

FIG. 4 illustrates an example of a system 400 for coalescing sequences for host side deduplication. The system 400 may comprise a coalescence component 404 hosted on a host device 430. The coalescence component 404 may be configured to receive a write command 402 from a client device. The write command 402 may comprise one or more data blocks, such as a first data block (A1), a second data block (A2), a third data block (A3), a fourth data block (A4), a fifth data block (A5), a sixth data block (A6), a seventh data block (A7), an eighth data block (A8), and a ninth data block (A9). The coalescence component 404 may be configured to evaluate the write command 402 to identify one or more data blocks already stored by a storage device (e.g., data blocks of the write command that comprise the same/redundant data as storage device data blocks already stored by the storage device). For example, the coalescence component 404 may determine signatures, such as hash values, for the data blocks within the write command 402. The coalescence component 404 may query a fingerprint data structure 406 using the signatures to identify which data blocks are already stored by the storage device. In an example, the coalescence component 404 may query the fingerprint data structure 406 to determine that the second data block (A2) is stored as a second storage device data block by the storage device, the fifth data block (A5) is stored as a fifth storage device data block by the storage device, the sixth data block (A6) is stored as a sixth storage device data block by the storage device, the seventh data block (A7) is stored as a seventh storage device data block by the storage device, and the eighth data block (A8) is stored as an eighth storage device data block by the storage device.

The first data block (A1) may be sent as a first write command (W1) 410, the third data block (A3) may be sent as a third write command (W3) 414, the fourth data block (A4) may be sent as a fourth write command (W4) 416, and the ninth data block (A9) may be sent as a ninth write command (W9) 426 to the storage device because the storage device does not comprise storage device data blocks comprising the same data as the first data block (A1), the third data block (A3), the fourth data block (A4), and the ninth data block (A9).

The coalescence component 404 may evaluate one or more adjacent block address structures within a set of adjacent block address structures 408 (e.g., adjacent block address structures corresponding to signatures of the second data block (A2), the fifth data block (A5), the sixth data block (A6), the seventh data block (A7), and the eighth data block (A8) that comprise data already stored by the storage device) to identify adjacent data blocks. In an example, the coalescence component 404 may determine that the second data block (A2) is not adjacent to a coalescence sequence threshold number of adjacent data blocks (e.g., the second data block (A2) may not be adjacent to a coalescence sequence threshold of at least 3 adjacent data blocks). Accordingly, the coalescence component 404 may send a command (C2) 412 to the storage device for the second data block (A2) (e.g., a write command or a deduplication command). In an example, the coalescence component 404 may determine that the fifth data block (A5) is not adjacent to the coalescence sequence threshold number of adjacent data blocks (e.g., the fifth data block (A5) may not be adjacent to the coalescence sequence threshold of at least 3 data blocks). Accordingly, the coalescence component 404 may send a command (C5) 418 to the storage device for the fifth data block (A5) (e.g., a write command or a deduplication command).

The coalescence component 404 may determine that the sixth data block (A6), the seventh data block (A7), and the eighth data block (A8) are adjacent data blocks (e.g., data blocks comprising the same data as storage device data blocks that are stored by the storage device in sequential/adjacent block addresses). Accordingly, the coalescence component 404 may coalesce the sixth data block (A6), the seventh data block (A7), and the eighth data block (A8) into a deduplication sequence. The coalescence component 404 may issue a host side write deduplication command 428 to the storage device based upon the deduplication sequence, as opposed to sending multiple deduplication commands that may otherwise decrease storage device performance and/or decrease network performance between the host device 430 and the storage device. In an example, the host side write deduplication command 428 is issued to a network storage controller configured to implement data storage commands on the storage device and/or other storage devices managed by the network storage controller.

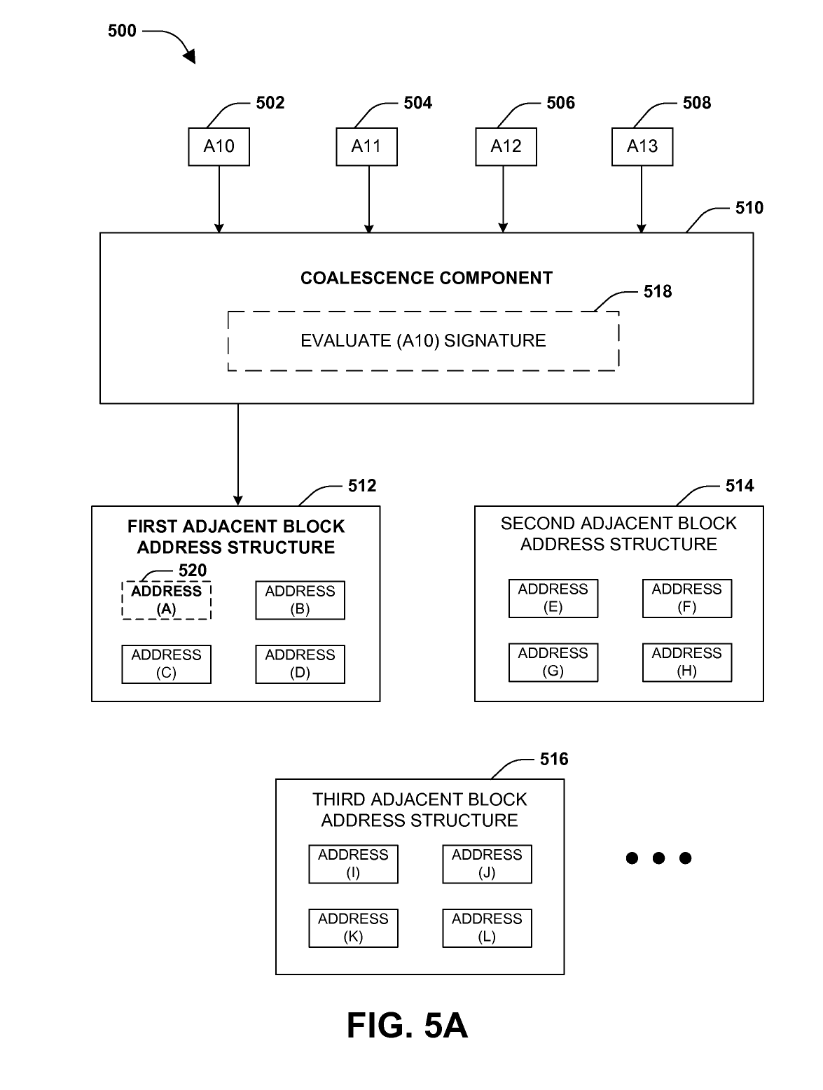

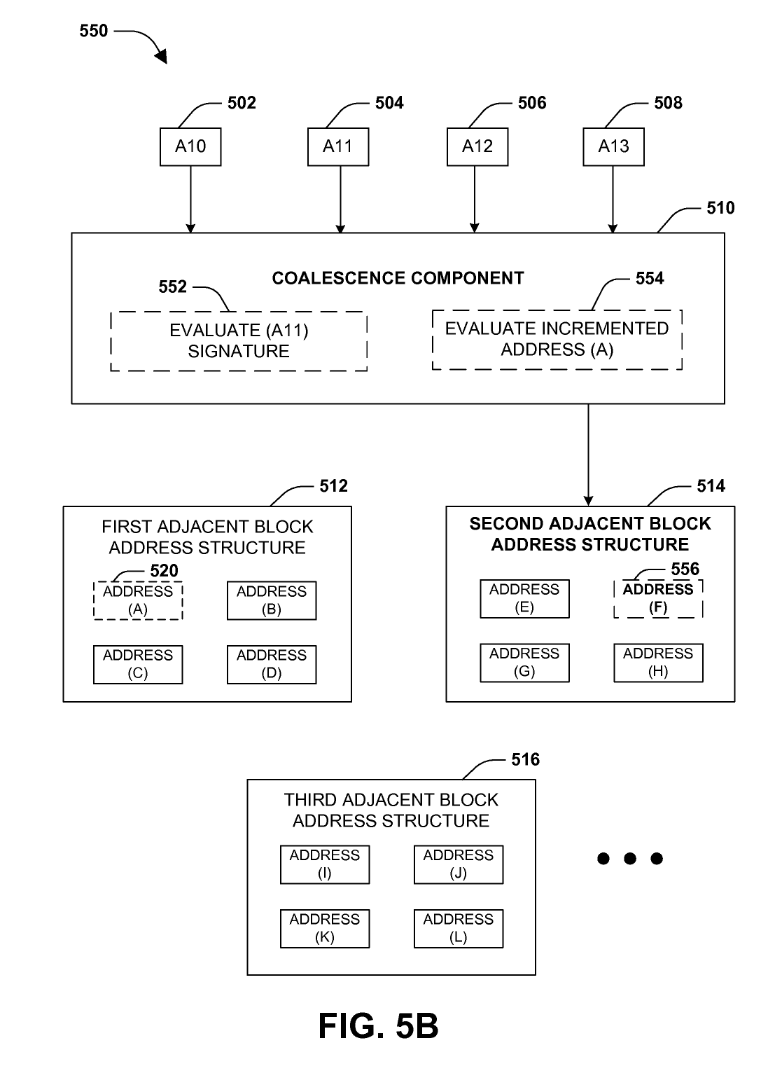

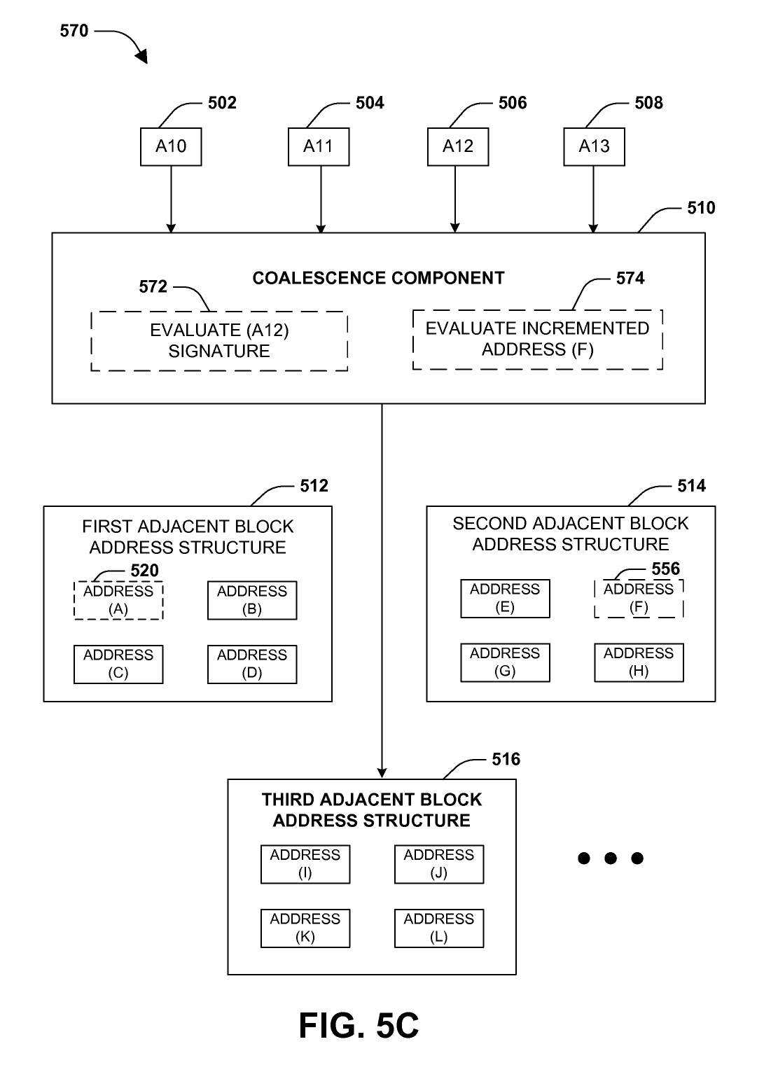

FIGS. 5A-5C illustrate examples of a coalescence component 510 evaluating one or more adjacent block address structures to identify adjacent data blocks. FIG. 5A illustrates an example 500 of the coalescence component 510 evaluating 518 a first adjacent block address structure 512 corresponding to a signature (A10) of a tenth data block (A10) 502. For example, the coalescence component 510 may receive a write command comprising a set of data blocks. The coalescence component 510 may determine that the tenth data block (A10) 502, an eleventh data block (A11) 504, a twelfth data block (A12) 506, and a thirteenth data block (A13) 508 are comprise the same data as storage device data blocks already stored within a storage device. The coalescence component 510 may determine the signature (A10), such as a hash value, of the tenth data block (A10) 502. The coalescence component 510 may determine that the first adjacent block address structure 512 corresponds to the signature (A10). Accordingly, the coalescence component 510 may evaluate 518, such as perform a breath first search, of the first adjacent block address structure 512 to identify a block address (A) 520 of a tenth storage device data block (A10) that corresponds to the tenth data block (A10). For example, the tenth storage device data block (A10), stored by the storage device, comprises the same data as the tenth data block (A10).

FIG. 5B illustrates an example 550 of the coalescence component 510 evaluating 552 a second adjacent block address structure 514 corresponding to a signature (A11) of the eleventh data block (A11) 504. The coalescence component 510 may have identified the block address (A) 520 as corresponding to the tenth storage device data block (A10) 502, stored by the storage device, which comprises the same data as the tenth data block (A10) 502, as illustrated in example 500 of FIG. 5A. The coalescence component 510 may compute the signature (A11), such as a hash value, of the eleventh data block (A11) 504. The coalescence component 510 may determine that the second adjacent block address structure 514 corresponds to the signature (A11). Accordingly, the coalescence component 510 may evaluate 552 the second adjacent block address structure 514. For example, the coalescence component 510 may increment the block address (A) 520 to obtain an incremented block address (A). The coalescence component 510 may evaluate 554 the second adjacent block address structure 514 to determine whether the incremented block address (A) corresponds to a block address of an eleventh storage device data block (A11), stored by the storage device, which comprises the same data as the eleventh data block (A11) 504. For example, the coalescence component 510 may identify the block address (F) 556 as corresponding to the incremented block address (A) and corresponding to the eleventh storage device data block (A11). In this way, the coalescence component 510 may determine that the tenth data block (A10) 502 and the eleventh data block (A11) 504 are adjacent data blocks (e.g., data blocks corresponding to the tenth storage device data block (A10) and the eleventh storage device data block (A11) that are stored sequentially/contiguous by the storage device).

FIG. 5C illustrates an example 570 of the coalescence component 510 evaluating 572 a third adjacent block address structure 516 corresponding to a signature (A12) of the twelfth data block (A12) 506. The coalescence component 510 may have identified the block address (F) 556 as corresponding to the eleventh storage device data block (A11) 504, stored by the storage device, which corresponds to the eleventh data block (A11) 504, and thus determined that the tenth data block (A10) 502 and the eleventh data block (A11) 504 are adjacent data blocks and that the tenth storage device data block (A10) and the eleventh storage device data block (A11) are adjacent storage device data blocks, as illustrated in example 500 of FIG. 5B. The coalescence component 510 may compute the signature (A12), such as a hash value, of the twelfth data block (A12) 506. The coalescence component 510 may determine that the third adjacent block address structure 516 corresponds to the signature (A12). Accordingly the coalescence component 510 may evaluate 572 the third adjacent block address structure 516. For example, the coalescence component 510 may increment the block address (F) 556 to obtain an incremented block address (F). The coalescence component 510 may evaluate 574 the third adjacent block address structure 516 to determine whether the incremented block address (F) corresponds to a block address of a twelfth storage device data block (A12), stored by the storage device, which comprises the same data as the twelfth data block (A12) 506. For example, the coalescence component 510 may not identify the block address, and thus may determine that the twelfth data block 506 is not an adjacent data block with respect to at least one of the tenth data block 502 or the eleventh data block 504. In this way, the coalescence component 510 may coalesce the tenth data block (A10) 502 and the eleventh data block (A11) 504, but not the twelfth data block (A12) 506, into a deduplication sequence that may be used to issue a host side write deduplication command to the storage server. It may be appreciated that other data blocks, adjacent block address structures, and/or potential sequences of data blocks may be evaluated to determine the deduplication sequences, and that FIGS. 5A-5C are merely simplistic examples for illustrative purposes.

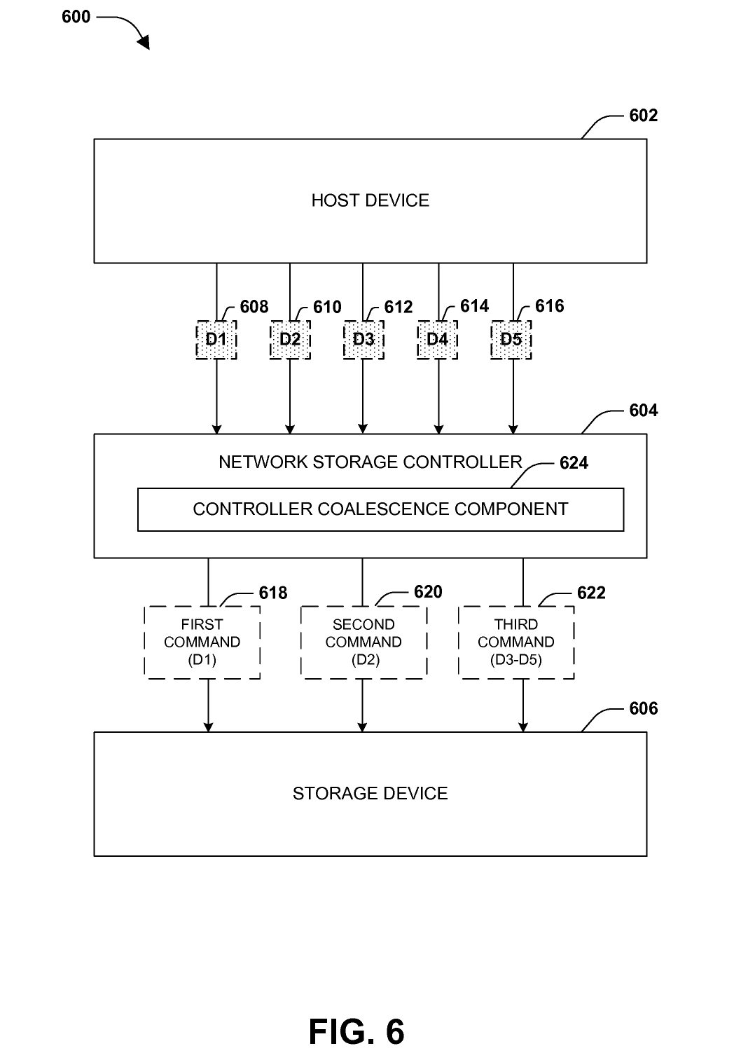

FIG. 6 illustrates an example of a system 600 for coalescing sequences for deduplication. The system 600 comprises a controller coalescence component 604. In an example, the controller coalescence component 624 is hosted by a network storage controller 604 configured to perform I/O operations, such as write commands, to a storage device 606 (e.g., a memory device, such as a hard drive). The controller coalescence component 624 may receive one or more deduplication commands from a host device 602 that is configured to provide a client device with access to the storage device 606 through the network storage controller 604. For example, the controller coalescence component 624 may receive a first deduplication command 608, a second deduplication command 610, a third deduplication command 612, a fourth deduplication command 614, and a fifth deduplication command 616 may be received from the host device 602. The first deduplication command 608 may specify that a first destination location of a first data block is to reference a first block address of a first storage device data block (e.g., create a first pointer in the first destination location to the first block address; copy the first storage device data block to the first destination location; etc.), the second deduplication command 610 may specify that a second destination location of a second data block is to reference a second block address of a second storage device data block (e.g., create a second pointer in the second destination location to the second block address; copy the second storage device data block to the second destination location; etc.), etc.

The controller coalescence component 624 may be configured to identify one or more adjacent data blocks. The controller coalescence component 624 may evaluate one or more adjacent block address structures, corresponding to signatures of the data blocks associated with the deduplication commands, to identify adjacent data blocks (e.g., corresponding to adjacent storage device data blocks). For example, the controller coalescence component 624 may determine that the first data block of the first deduplication command 608 and the second data block of the second deduplication command 610 are not adjacent to a coalescence sequence threshold number of adjacent data blocks, such as 3 adjacent data blocks. Accordingly, the controller coalescence component 624 may perform a first command 618 (e.g., to create a pointer to the first storage device data block in the first destination location or to copy the first storage device data block from the first block address to the first destination location) on the storage device 606 for the first deduplication command 608. The controller coalescence component 624 may perform a second command 620 (e.g., to create a pointer to the second storage device data block in the second destination location or to copy the second storage device data block from the second block address to the second destination location) on the storage device 606 for the second deduplication command 608.

The controller coalescence component 624 may determine that a third data block of the third deduplication command (D3) 612, a fourth data block of the fourth deduplication command (D4) 614, and the fifth data block of the fifth deduplication command (D5) 616 may be adjacent data blocks. Accordingly, the controller coalescence component 624 may coalesce the third deduplication command 612, the fourth deduplication command 614, and the fifth deduplication command 616 into a deduplication write sequence. The controller coalescence component 624 may perform a third command 622 on the storage device 606 based the deduplication write sequence. Because the third command 622 corresponds to multiple data blocks, performance of the storage device 606 may be improved due to a reduction in the number of commands (e.g., I/O operations) issued to the storage device 606.

In an example, the network storage controller 604 comprises a backup network storage controller that may perform deduplication and coalescing of sequences. For example, the backup network storage controller may evaluate write commands to identify data blocks stored by the storage device 606. The backup network storage controller may perform deduplication with respect to such data blocks. For example, the backup network storage controller may identify one or more adjacent data blocks that may be coalesced into a deduplication write sequence that may be used to perform a single command on the storage device 606 for the coalesced adjacent data blocks.

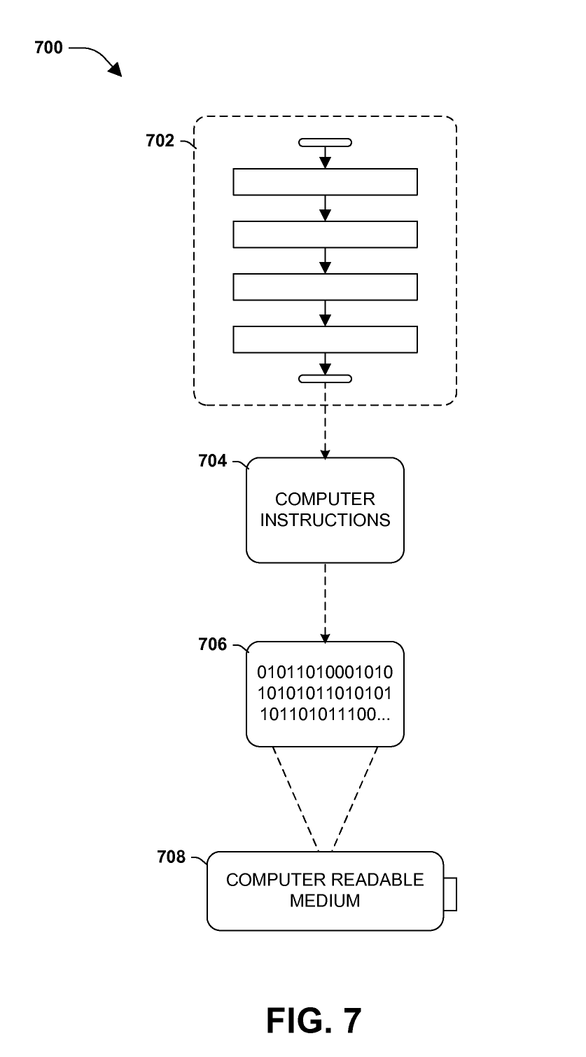

Still another embodiment involves a computer-readable medium comprising processor-executable instructions configured to implement one or more of the techniques presented herein. An example embodiment of a computer-readable medium or a computer-readable device that is devised in these ways is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 300 of FIG. 3, for example. In some embodiments, the processor-executable instructions 704 are configured to implement a system, such as at least some of the exemplary system 400 of FIG. 4 and/or at least some of the exemplary system 600 of FIG. 6, for example. Many such computer-readable media are contemplated to operate in accordance with the techniques presented herein.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component is localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for coalescing sequences for host side deduplication, comprising:
receiving a write command comprising a set of data blocks that are to be written to a storage device by a host device, the write command received by the host device from a client device;
determining that a first data block and a second data block within the set of data blocks are stored by the storage device; and
responsive to determining that the first data block and the second data block are adjacent data blocks:
coalescing the first data block and the second data block into a deduplication sequence; and
issuing a host side write deduplication command to the storage device based upon the deduplication sequence.

2. The method of claim 1, comprising:
determining that a third data block within the set of data blocks is stored by the storage device; and
responsive to determining that the third data block is an adjacent data block with respect to at least one of the first data block or the second data block,
coalescing the third data block into the deduplication sequence.

3. The method of claim 1, the determining that the first data block and the second data block are adjacent data blocks comprising:
determining a first signature for the first data block;
determining a second signature for the second data block; and
evaluating one or more adjacent block address structures, corresponding to the first signature and the second signature, to determine that the first data block and the second data block are adjacent data blocks.

4. The method of claim 3, a first adjacent block address structure comprising a first left leaning red-black tree.

5. The method of claim 3, the evaluating one or more adjacent block address structures comprising:
evaluating a first adjacent block address structure, corresponding to the first signature, to identify a first block address of a first storage device data block corresponding to the first data block;
incrementing the first block address to obtain an incremented first block address;
evaluating a second adjacent block address structure, corresponding to the second signature, to determine whether the incremented first block address corresponds to a second block address of a second storage device data block corresponding to the second data block; and
responsive to determining that the incremented first block address corresponds to the second block address, determining that the first data block and the second data block are adjacent data blocks.

6. The method of claim 1, comprising:
maintaining a coalescence sequence threshold corresponding to a threshold number of adjacent data blocks;
responsive to the deduplication sequence satisfying the coalescence sequence threshold, issuing the host side write deduplication command; and
responsive to the deduplication sequence not satisfying the coalescence sequence threshold, refraining from issuing the host side write deduplication command.

7. The method of claim 6, comprising:
evaluating communication between the host device and the storage device to identify a storage metric; and
dynamically adjusting the coalescence sequence threshold based upon the storage metric.

8. The method of claim 1, the determining that a first data block and a second data block within the set of data blocks are stored by the storage device, comprising:
determining a first signature for the first data block;
determining a second signature for the second data block;
querying a fingerprint data structure using the first signature to identify a first entry indicating that the storage device comprises a first storage device data block corresponding to the first data block; and
querying the fingerprint data structure using the second signature to identify a second entry indicating that the storage device comprises a second storage device data block corresponding to the second data block.

9. The method of claim 1, the issuing a host side write deduplication command comprising:
issuing the host side write deduplication command as a single communication command between the host device and the storage device.

10. The method of claim 1, the host side write deduplication command specifying that a first destination location of the first data block is to reference a first block address of a first storage device data block and a second destination location of the second data block is to reference a second block address of a second storage device data block.

11. The method of claim 3, the evaluating one or more adjacent block address structures comprising:
performing a breadth first search of a first adjacent block address structure to determine that a first block address, corresponding to the first data block, is within the first adjacent block address structure.

12. The method of claim 3, the evaluating one or more adjacent block address structures comprising:
identifying a set of potential sequences of adjacent data blocks; and
performing a sequence pruning technique to select a potential sequence from the set of potential sequences to use for the coalescing.

13. A system for coalescing sequences for host side deduplication, comprising:
a coalescence component, implemented on a host device, configured to:
receive a write command from a client device, the write command comprising a set of data blocks that are to be written to a storage device by the host device;
determine that a first data block and a second data block within the set of data blocks are stored by the storage device; and
responsive to determining that the first data block and the second data block are adjacent data blocks:
coalesce the first data block and the second data block into a deduplication sequence; and
issue a host side write deduplication command to the storage device based upon the deduplication sequence.

14. The system of claim 13, the coalescence component configured to:
determine a first signature for the first data block;
determine a second signature for the second data block; and
evaluate one or more adjacent block address structures, corresponding to the first signature and the second signature, to determine that the first data block and the second data block are adjacent data blocks.

15. The system of claim 14, the coalescence component configured to:
evaluate a first adjacent block address structure, corresponding to the first signature, to identify a first block address of a first storage device data block corresponding to the first data block;
increment the first block address to obtain an incremented first block address;
evaluate a second adjacent block address structure, corresponding to the second signature, to determine whether the incremented first block address corresponds to a second block address of a second storage device data block corresponding to the second data block; and
responsive to determining that the incremented first block address corresponds to the second block address, determining that the first data block and the second data block are adjacent data blocks.

16. The system of claim 13, the coalescence component configured to:
determine a first signature for the first data block;
determine a second signature for the second data block;
query a fingerprint data structure using the first signature to identify a first entry indicating that the storage device comprises a first storage device data block corresponding to the first data block; and
query the fingerprint data structure using the second signature to identify a second entry indicating that the storage device comprises a second storage device data block corresponding to the second data block.

17. The system of claim 13, the coalescence component configured to:
maintain a coalescence sequence threshold corresponding to a threshold number of adjacent data blocks;
responsive to the deduplication sequence satisfying the coalescence sequence threshold, issue the host side write deduplication command; and
responsive to the deduplication sequence not satisfying the coalescence sequence threshold, refrain from issuing the host side write deduplication command.

18. A system for coalescing sequences for deduplication, comprising:
a controller coalescence component configured to:
receive a first deduplication command from a host device, the first deduplication command specifying that a first destination location of a first data block is to reference a first block address of a first storage device data block;
receive a second deduplication command from the host device, the second deduplication command specifying that a second destination location of a second data block is to reference a second block address of a second storage device data block;
coalesce the first deduplication command and the second deduplication command into a deduplication write sequence; and
perform a command on a storage device based upon the deduplication write sequence.

19. The system of claim 18, the controller coalescence component hosted by a network storage controller.

20. The system of claim 18, controller coalescence component configured to:
determine a first signature for the first data block;
determine a second signature for the second data block; and
evaluate one or more adjacent block address structures, corresponding to the first signature and the second signature, to determine that the first data block and the second data block are adjacent data blocks.
